(19) United States
(12) Patent Application Publication
(10) Pub. No.: US 2026/0037126 A1
(43) Pub. Date: Feb. 5, 2026

(54) MEMORY SUB-SYSTEM FOR ADJUSTING MEMORY DEVICE PROGRAMMING PARAMETERS

(71) Applicant: MICRON TECHNOLOGY, INC., Boise, ID (US)

(72) Inventors: Peng Zhang, Los Altos, CA (US); Hanping Chen, San Jose, CA (US); Murong Lang, San Jose, CA (US); Zhenming Zhou, San Jose, CA (US)

(21) Appl. No.: 18/790,124

(22) Filed: Jul. 31, 2024

(51) Int. Cl. G06F 3/06

(52) U.S. Cl. CPC G06F 3/061; G06F 3/0659; G06F 3/0673

(57) ABSTRACT

Various aspects of the present disclosure relate to a memory sub-system for adjusting memory device programming parameters. A processing device receives a write command to write data to the memory device. The processing device determines that the write command is an operating system write command. The processing device loads a first set of values for respective parameters responsive to determining that the write command is the operating system write command. The processing device writes the data to the memory device using the first set of values. The processing device loads a second set of values for the respective parameters after writing the data to the memory device using the second set of values.

### TECHNICAL FIELD

Aspects of the disclosure relate generally to memory sub-systems, and more specifically, to a memory sub-system for adjusting memory device programming parameters.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various aspects of the disclosure.

FIG. 1 illustrates an example computing system that includes a memory sub-system, in accordance with some aspects of the present disclosure.

FIG. 2 is a sequence diagram illustrating an example method of adjusting memory device programming parameters for programming an operating system of the memory device, in accordance with some aspects of the present disclosure.

FIG. 3 is a sequence diagram illustrating an example method of adjusting memory device programming parameters using step static offsets, in accordance with some aspects of the present disclosure.

FIG. 4 is a flow diagram of an example method of adjusting memory device programming parameters for programming an operating system of the memory device, in accordance with some aspects of the present disclosure.

FIG. 5 is a flow diagram of an example method of adjusting memory device programming parameters using step static offsets, in accordance with some aspects of the present disclosure.

FIG. 6 is a block diagram of an example computer system in which some aspects of the present disclosure may operate.

### DETAILED DESCRIPTION

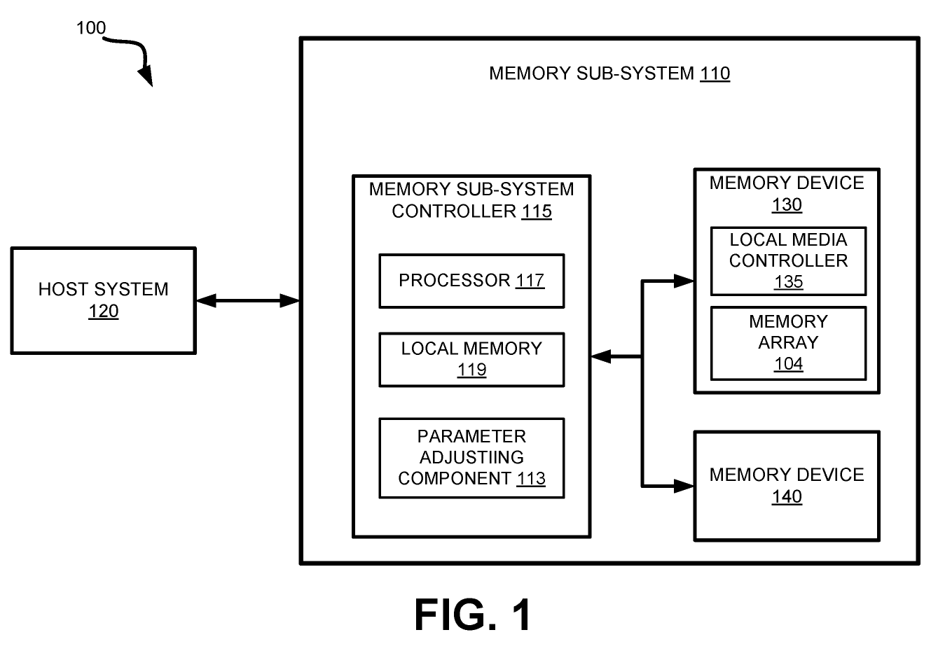

Aspects of the present disclosure are directed to adjusting memory device programming parameters. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. Memory cells are formed onto a silicon wafer in a rectangular array; the memory cells may be joined by conductive lines referred to as wordlines and bitlines. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

Data retention (DR) refers to the ability of a memory device to retain stored information over a period of time. This is an important characteristic for non-volatile memory devices, such as flash memory devices, which are expected to retain data even when powered off. Post-data retention read performance indicates a performance characteristic of the memory device when reading data that has been retained for a certain period. For example, post-data retention read performance can measure how accurately the memory device reads data after it has been stored for the certain period, ensuring that the data is still accessible and the device performs efficiently. Out-of-box experience (OOBE) refers to an initial performance of a memory device when the memory device is first unboxed and powered on. Memory devices can undergo very long beginning of life (BOL) power-off data retention before shipped to every customer. Beginning of life power-off retention refers to the data retention capability of a memory device when it is new or has just been deployed. OOBE requirements may indicate a maximum allowed operating system (OS) loading time when the memory device is used for the first time.

A wordline is a horizontal control line in a memory array that connects to the gate terminals of a row of transistors or memory cells. Activating a wordline allows the cells in that row to be read from or written to. In some memory devices, multiple layers of memory cells may be stacked vertically to increase storage density. Tier number indicates how many such layers are present, which may impact the storage capacity and performance of the device. Pitch size refers to the distance between identical points in adjacent memory cells or lines in a memory array. Pitch size determines the density of the memory array. A smaller pitch size allows for higher density and greater storage capacity in a given area. Wordline variation may increase with tier numbers and pitch size. Wordline variation refers to the differences or inconsistencies in the electrical characteristics or physical dimensions of wordlines within a memory device. Variations in wordlines can impact the performance and reliability of memory cells, leading to issues such as inconsistent read/write speeds and potential data errors. Trigger rate is the frequency at which a certain event or condition occurs in a memory device. Specifically, a data retention trigger rate refers to the frequency at which data retention mechanisms or tests are initiated to ensure the integrity of stored data. This metric is important for evaluating how often a memory device checks and maintains the retention of data, thereby ensuring long-term reliability, especially in non-volatile memory. OOBE data retention trigger rates may be gated (for example, limited) by a certain number of wordlines (for example, a top two wordlines) due to lateral charge migration (LCM). Lateral charge migration is the movement of electrical charge horizontally between adjacent memory cells or components within a memory device, which can lead to data corruption or errors, particularly in tightly packed memory arrays. Controlling lateral charge migration is important for maintaining data integrity and device reliability.

Generally, memory devices may be programmed to prioritize either improving data retention and reliability at an end of life (EOL) of the memory device by increasing program times (tprog) of the memory device, or reducing programming times by reducing data retention capabilities at a beginning of life (BOL) of the memory device. However, OOBE requirements may require both high data retention trigger rates and high write performance at the beginning of life. Satisfying OOBE data retention performance requirements can be challenging due to high trigger rates and long read error handling (REH) latency. Read error handling latency refers to the time delay between the occurrence of a read error and the successful correction and retrieval of the correct data. To satisfy OOBE specifications, features that enhance beginning of life data retention trigger rate without compromising write performance are needed.

Aspects of the present disclosure address the above and other deficiencies by providing a memory sub-system for adjusting memory device programming parameters. In some aspects, a processing device may adjust the memory device programming parameters for programming an operating system of the memory device. For example, the processing device may receive a write command and may load a first set of values (which may be referred to as a first trim set) for respective parameters responsive to determining that the write command is associated with programming an operating system of the memory device (for example, responsive to determining that the write command includes operating system data for programming an operating system of the memory device). The parameters may include at least one of a timing parameter or an accuracy parameter, and the first set of values for the respective parameters may include a higher value for the timing parameter and a higher value for the accuracy parameter. Therefore, the processing device, using the first set of values for the respective parameters, may program the memory device with initial programming data (such as operating system data) using a higher accuracy but at a slower speed. After writing the data to the memory device, the processing device may load a second set of values (which may be referred to as a second trim set) for the respective parameters, where the second set of values includes a lower value for the timing parameter and a lower value for the accuracy parameter. Therefore, the processing device, using the second set of values, may program the memory device with standard data (for example, data that is not associated with the operating system of the memory device) using a lower accuracy but a faster speed.

In some aspects, the processing device may adjust the memory device programming parameters using step static offsets. A step static offset refers to a constant voltage offset that is added to an initial program voltage step to improve a likelihood of accurate and consistent programming of memory cells. The processing device may receive a write command to write data to a plurality of memory cells of the memory device, determine whether a program erase cycle count of the plurality of memory cells is less than a program erase cycle count threshold, and determine whether the wordline is included in a list of wordlines. The list of wordlines may include a number of wordlines or a percentage of wordlines having a lowest performance characteristic. If the program erase cycle count of the plurality of memory cells is less than the program erase cycle count threshold, and the wordline is included in the list of wordlines, the processing device may load one or more step static offsets and write the data to the plurality of memory cells using the one or more step static offsets, where the step static offsets include at least one of a program voltage step parameter or a program verify parameter. In some cases, the program voltage step parameter defines an incremental increase in voltage applied during each programming step to gradually charge the memory cell to its desired state, and the program verify parameter is a voltage level or threshold that can be used to confirm that a memory cell has been programmed correctly to the intended value during the programming process. Alternatively, if the program erase cycle count of the plurality of memory cells is greater than or equal to the program erase cycle count threshold, or the wordline is not included in the list of wordlines, the processing device may write the data to the plurality of memory cells using a standard write operation (for example, without using the step static offsets).

Some advantages of the present disclosure include enabling an improved beginning of life data retention trigger rate for a memory device. Some advantages of the present disclosure include enabling high beginning of life data retention trigger rates without reducing a write performance of the memory device. Some advantages of the present disclosure include enabling different parameters to be selected and used for operating system write operations and standard write operations. For example, some advantages of the present disclosure include performing operating system write operations at slower speeds but with higher accuracy, while performing standard memory device write operations at faster speeds but with potentially reduced accuracy. Some advantages of the present disclosure include enabling loading a first set of values for respective parameters responsive to detecting that a write command is associated with programming an operating system of the memory device or loading a second set of values for the respective parameters responsive to detecting that the write command is not associated with the operating system of the memory device. Some advantages of the present disclosure include enabling step static offsets to be loaded based on program erase counts and wordline characteristics. For example, some advantages of the present disclosure include enabling loading step static offsets based on a program erase cycle count being lower than a program erase cycle count threshold and based on a wordline being included in a list of wordlines having a worst performance characteristic. Some advantages of the present disclosure include enabling loading step static offsets regardless of the processing device being configured to determine whether a write command is an operating system write command or a standard write command. These example advantages, among others, are described in more detail below.

FIG. 1 illustrates an example computing system 100 that includes a memory sub-system 110, in accordance with some aspects of the present disclosure. The memory sub-system 110 can include media, such as one or more volatile memory devices (e.g., memory device 140), one or more non-volatile memory devices (e.g., one or more memory device(s) 130), or a combination of such.

The memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some aspects, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL interface). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some aspects, each of the memory devices 130 can include one or more arrays of memory cells such as SLCs, MLCs, TLCs, QLCs, or any combination of such. In some aspects, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some aspects, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in some other aspects, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some aspects, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some aspects, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some aspects, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some aspects, one or more components of memory sub-system 110 can be omitted.

In some aspects, the memory sub-system 110 includes a parameter adjusting component 113 that can be used to adjust memory device programming parameters. In some aspects, the parameter adjusting component 113 can adjust memory device programming parameters based on receiving a write command that is associated with programming an operating system of the memory device. For example, the parameter adjusting component 113 may load a first set of values for respective parameters responsive to determining that a write command is an operating system write command. The parameters may include at least one of a timing parameter or an accuracy parameter, and the first set of values for the respective parameters may include a higher value for the timing parameter and a higher value for the accuracy parameter. After writing the data to the memory device, the parameter adjusting component 113 may load a second set of values for the respective parameters, where the second set of values includes a lower value for the timing parameter and a lower value for the accuracy parameter. In some other aspects, the parameter adjusting component 113 may adjust the memory device programming parameters using step static offsets. The parameter adjusting component 113 may load one or more step static offsets responsive to determining that a program erase cycle count of a plurality of memory cells is less than a program erase cycle count threshold and responsive to determining that the wordline associated with the plurality of memory cells is included in the list of wordlines. Alternatively, the parameter adjusting component 113 may load standard values for one or more programming parameters responsive to determining that the program erase cycle count of the plurality of memory cells is greater than or equal to the program erase cycle count threshold or responsive to determining that the wordline associated with the plurality of memory cells is not included in the list of wordlines. Additional details regarding these features are described below.

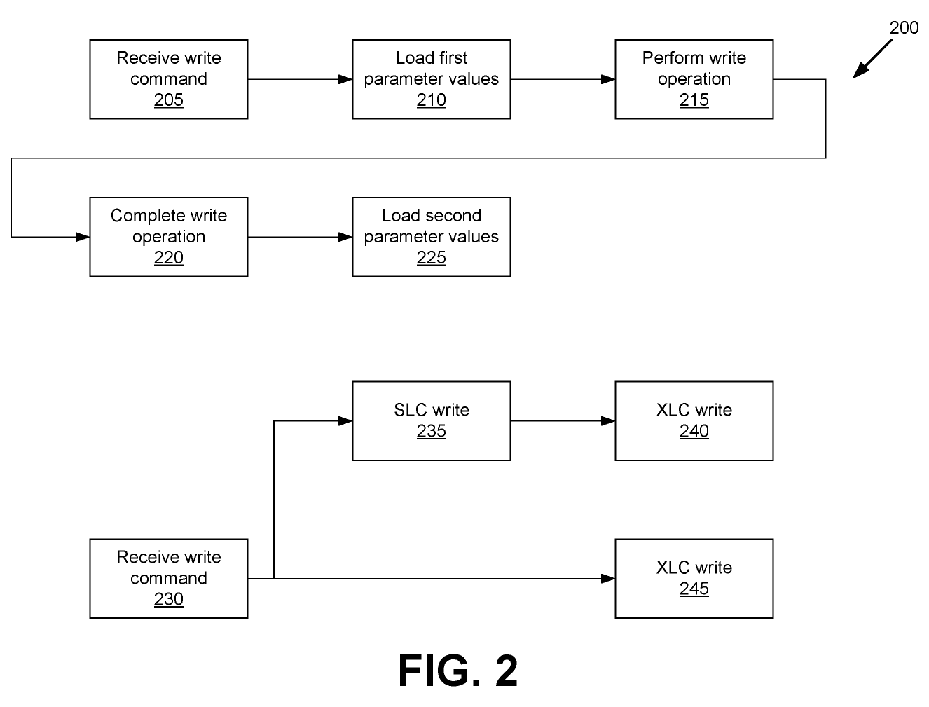

FIG. 2 is a sequence diagram illustrating an example method 200 of adjusting memory device programming parameters for programming an operating system of the memory device, in accordance with some aspects of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 200 is performed by the parameter adjusting component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 205, the processing logic receives a write command. The write command may include data to be written to a memory device, such as the memory device 140. In some aspects, the write command may indicate for the processing logic to write the data to one or more memory cells of the memory device. For example, the host system 120 may send a write command to the processing logic that indicates for the processing logic to write data to one or more memory cells of the memory device 140.

At operation 210, the processing logic loads first parameter values. The processing logic may load the first parameter values based on the write command being an initial write command associated with programming an operating system of the memory device. In some aspects, the initial write command may be an operating system write command that includes data for programming an operating system of the memory device. The first parameter values may enable the processing logic to write the data to the memory device with a higher degree of accuracy. For example, the first parameter values may include a higher value for an accuracy parameter of the memory device. Additionally, or alternatively, the first parameter values may enable the processing logic to write the data to the memory device at a slower speed. For example, the first parameter values may include a higher value for a time parameter of the memory device.

In some aspects, the processing logic may determine that the write command is the initial write command associated with the operating system of the memory device based on a characteristic of the initial write command that distinguishes the initial write command from a standard write command. For example, the initial write command may include a flag set in an internal register indicating that the command is associated with the operating system of the memory device (for example, indicating that the command includes operating system data for programming an operating system of the memory device).

In some aspects, the first parameter values may be referred to as a first trim set or an internal trim set. The first trim set may not be accessible by the host system. In the context of memory devices, a trim set refers to a collection of parameters or values that can be used to fine-tune or calibrate the performance of the memory device. These parameters are typically stored in the non-volatile memory and can be used to adjust various aspects of the device’s operation (such as a programming speed or accuracy) to ensure optimal performance and reliability.

At operation 215, the processing logic performs a write operation. The processing logic performs the write operation using the first parameter values. For example, the processing logic may write the data (such as the operating system data) to the memory device using a higher accuracy but a slower speed. This may improve a likelihood that the data is written accurately to the memory device during time when speed is less important, such as during a process of programming the operating system of the memory device.

At operation 220, the processing logic completes the write operation. The processing logic may complete the write operation based on all of the data included in the write command being written to the memory device.

At operation 225, the processing logic loads a second set of parameter values. The second set of parameter values may be a default set of parameter values. The processing logic may load the second parameter values based on the write operation being complete. In some aspects, the second parameter values may be referred to as a second trim set or an external trim set. The external trim set may be accessible by the host system. The second parameter values may enable the processing logic to write the data to the memory device with a lower degree of accuracy. For example, the second parameter values may include a lower value for the accuracy parameter of the memory device. Additionally, or alternatively, the second parameter values may enable the processing logic to write the data to the memory device at a faster speed. For example, the second parameter values may include a lower value for the time parameter of the memory device.

At operation 230, the processing logic receives a write command. The write command may be different than the write command received in connection with operation 205. For example, the write command may include regular data, such as data that is not associated with the operating system of the memory device. The processing logic may write the data to the memory device using the second parameter values, for example, since the data is non-operating system data.

In some aspects, the processing logic may perform an initial write operation to write the data to single-level cell (SLC) memory of the memory device, such as an SLC cache of the memory device, which is faster and more reliable than other types of memory. The processing logic may then move the data from the SLC memory to multiple-level cell (XLC) memory, which enables the memory device to store larger amounts of data. Writing the data to the SLC memory first, and later moving the data from the SLC memory to the XLC memory, may provide fast initial write speeds, higher endurance, and reduced write amplification. However, this may also require more complex controller algorithms and may increase latency in the memory device write operations. In some other aspects, the data may be written directly to XLC memory without using the SLC cache. This may enable a simpler controller design without the need for complex data migration algorithms. However, this may also result in slower write speeds and increased write amplification.

At operation 235, the processing logic performs an SLC write. The single-bit storage in the SLC memory means that each cell can be in one of two states (0 or 1), resulting in straightforward read and write processes that minimize the chances of errors.

At operation 240, the processing logic performs a multiple-level cell (XLC) write. XLC memory can be categorized based on the number of bits stored per cell. Multi-level cell (MLC) memory stores two bits per cell, allowing for four possible states (00, 01, 10, 11). Triple-level cell (TLC) memory stores three bits per cell, resulting in eight possible states (000 to 111). Quad-level cell (QLC) memory stores four bits per cell, leading to sixteen possible states (0000 to 1111).

At operation 245, the processing logic performs an XLC write. In this example, the processing logic may write data directly to the XLC memory, rather than performing an initial write to the SLC memory and moving the data to the XLC memory.

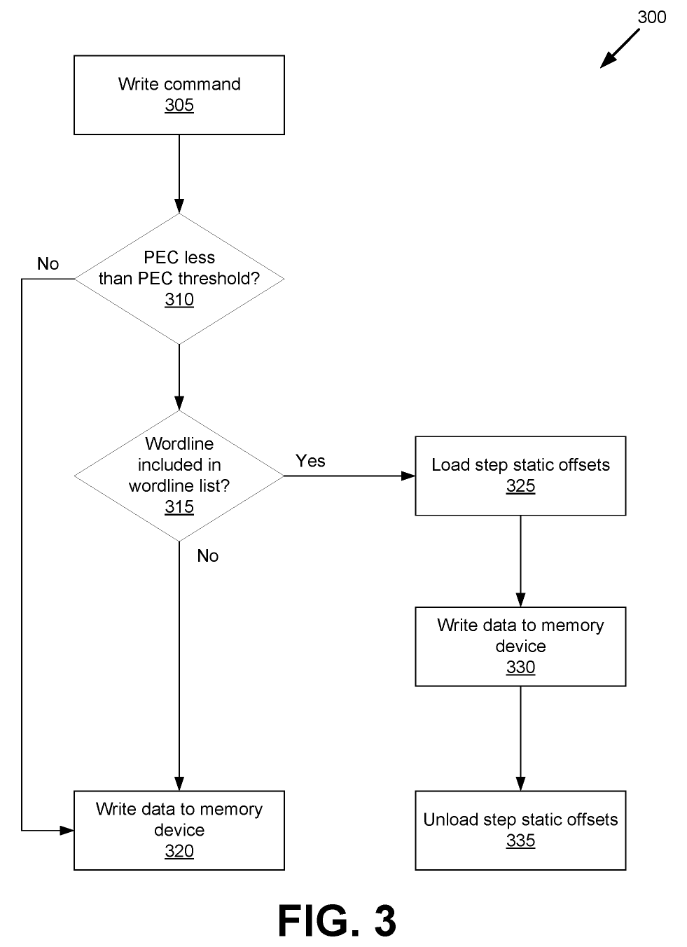

FIG. 3 is a sequence diagram illustrating an example method 300 of adjusting memory device programming parameters using step static offsets, in accordance with some aspects of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 300 is performed by the parameter adjusting component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

A step static offset refers to a constant voltage offset that can be added to an initial program voltage step of a memory cell to improve a likelihood of accurate and consistent programming of the memory cell. In some examples, applying a step static offset (for example, adding the step static offset to the initial program voltage step) reduces a programming gate step size. A gate step is an incremental voltage step applied to a gate of a memory cell during a programming operation. Smaller gate steps can result in increased control over a threshold voltage (Vt) distribution. By using smaller gate steps, the variance in threshold voltages across the memory cells of the memory device is minimized, leading to a more uniform threshold voltage distribution. A smaller threshold voltage distribution can increase the reliability of data read operations since the threshold voltages of programmed cells are more consistent. Applying step static offsets can result in numerous advantages, including improved EOL reliability, reduced gate step size, increased read window budget (RWB), and more consistent read levels, among other examples. However, in some cases, applying step static offsets too frequently (for example, to a large percentage of memory cells of the memory device) can lead to increased programming times.

At operation 305, the processing logic receives a write command. The write command may include data to be written to a memory device, such as the memory device 140. In some aspects, the write command may indicate for the processing logic to write the data to a plurality of memory cells of the memory device. For example, the host system 120 may send a write command to the processing logic that indicates for the processing logic to write data to the plurality of memory cells of the memory device 140. As described herein, each memory cell of the plurality of cells may be connected to a wordline of a plurality of wordlines of the memory device.

At operation 310, the processing logic determines whether a program erase cycle (PEC) count associated with the write operation is less than a PEC count threshold. For example, the processing logic may determine whether a PEC count of a wordline connected to the plurality of memory cells is less than a PEC count threshold of the wordline. A PEC refers to a number of times that a memory cell (or a wordline connected to a plurality of memory cells) has undergone a complete cycle of programming (writing data) and erasing (clearing data). In some aspects, the PEC count threshold may be small, for example, to apply to a beginning of life of the memory device. For example, the PEC count threshold may be set to a value of thirty.

At operation 315, the processing logic determines whether the wordline associated with the write operation is included in a wordline list. The wordline list may be a list of wordlines having a lowest (worst) performance characteristic. For example, the wordline list may include two or more wordlines having a lowest reliability characteristic or a highest trigger rate characteristic. In some aspects, the wordline list may include a small percentage of wordlines compared to the total number of wordlines in the memory device. For example, two wordlines out of one hundred wordlines may be sufficient to significantly impact the performance of the memory device by creating a bottleneck effect.

At operation 320, the processing logic writes the data to the memory device. The processing logic may write the data to the plurality of memory cells of the memory device based on the PEC count not being less than the PEC threshold or based on the wordline not being included in the wordline list. For example, the processing logic may determine that the PEC count of the wordline is greater than or equal to the PEC count threshold, or may determine that the wordline is not included in the wordline list, and may write the data to the plurality of memory cells without using any step static offsets.

At operation 325, the processing logic loads one or more step static offsets. The processing logic may load the one or more step static offsets responsive to determining that the PEC count is less than the PEC count threshold and responsive to determining that the wordline is included in the wordline list. In some aspects, the one or more step static offsets include at least one of a program voltage step parameter or a program verify parameter. The program voltage step parameter refers to an incremental increase in voltage applied to a memory cell during a programming operation. This stepwise application of voltage helps in gradually moving the cell to a desired threshold voltage, improving a likelihood of accurate data storage and minimizing the risk of over-programming. The program verify parameter is a criterion (or set of criteria) used to determine whether a memory cell has reached a target threshold voltage after a programming step. This verification improves a likelihood that the cell has been correctly programmed, maintaining data integrity and preventing errors.

At operation 330, the processing logic writes the data to the memory device. For example, the processing logic writes the data to the plurality of memory cells of the memory device using the one or more step static offsets. As described herein, the processing logic applies the step static offsets when programming the lowest performing wordlines (included in the list of wordlines) and at the BOL of the memory device (as determined by the PEC count). This can improve the BOL data retention of the memory device while having minimal to no impact on the write performance, for example, due to the limited number of wordlines to which the step static offsets are applied.

At operation 335, the processing logic unloads the one or more step static offsets. For example, the memory device returns to default programming mode for writing data to the memory device.

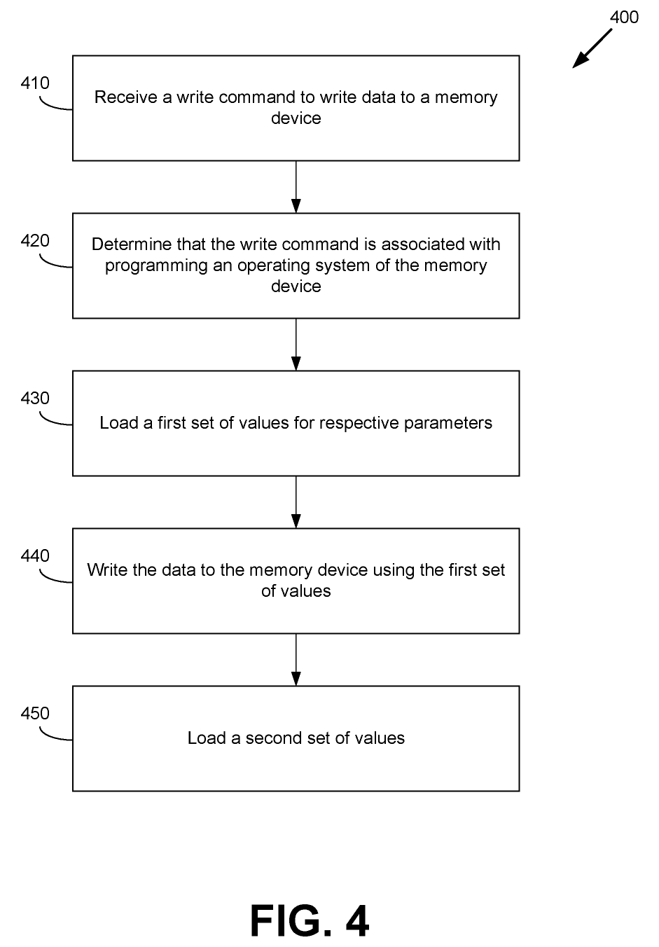

FIG. 4 is a flow diagram of an example method 400 of adjusting memory device programming parameters for programming an operating system of the memory device, in accordance with some aspects of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 400 is performed by the parameter adjusting component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 410, the progressing logic receives a write command to write data to the memory device.

At operation 420, the processing logic determines that the write command is associated with programming an operating system of the memory device. In some implementations, the processing logic, to determine that the write command is associated with programming the operating system of the memory device, determines that the write command includes operating system data for programming an operating system of the memory device.

At operation 430, the processing logic loads a first set of values for respective parameters responsive to determining that the write command is associated with the programming the operating system of the memory device. In some implementations, the respective parameters include a timing parameter and an accuracy parameter. In some implementations, the first set of values includes a higher value for the timing parameter and a higher value for the accuracy parameter. In some implementations, the respective parameters are step static offset parameters that include at least one of a program voltage step parameter or a program verify parameter.

At operation 440, the processing logic writes the data to the memory device using the first set of values.

At operation 450, the processing logic loads a second set of values for the respective parameters. In some implementations, the second set of values includes a lower value for the timing parameter and a lower value for the accuracy parameter. In some implementations, a quantity of values in the first set of values is less than a quantity of values in the second set of values. In some implementations, the second set of values is a default set of values for writing standard data that is not associated with the programming of the operating system of the memory device.

In some implementations, the processing logic receives a second write command to write second data to the memory device, determines that the second write command is not associated with the programming of the operating system of the memory device, and writes the second data to the memory device using the second set of values for the respective parameters.

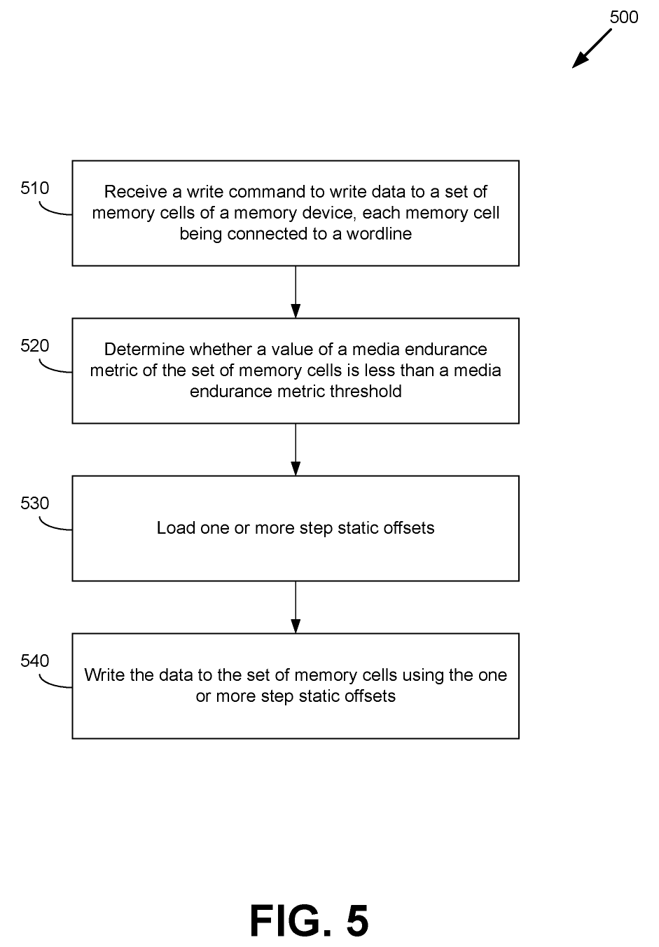

FIG. 5 is a flow diagram of an example method 500 of adjusting memory device programming parameters using step static offsets, in accordance with some aspects of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 500 is performed by the parameter adjusting component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 510, the processing logic determines a command to write data to a set of memory cells of the memory device, each memory cell of the set of memory cells being connected to a wordline of a plurality of wordlines of the memory device. In some implementations, receiving the command to write data to the set of memory cells of the memory device comprises receiving a request to write the data to a triple-level cell memory of the memory device, or determining to move the data from a single-level cell memory of the memory device to the triple-level cell memory of the memory device.

At operation 520, the processing logic determines whether a value of a media endurance metric of the set of memory cells is less than a media endurance metric threshold. In some implementations, the media endurance metric is a program erase cycle count of the set of memory cells.

In some implementations, the processing logic determines whether the wordline is included in a list of wordlines responsive to determining that the value of the media endurance metric of the set of memory cells is less than the media endurance metric threshold. In some implementations, the list of wordlines includes one or more wordlines having performance characteristics that do not satisfy a performance characteristic threshold. In some implementations, the performance characteristics include at least one of a wear characteristic, a resistance characteristic, an error rate characteristic, a voltage control characteristic, a capacitance characteristic, or a power consumption characteristic.

At operation 530, the processing logic loads one or more step static offsets responsive to determining that the wordline is included in the list of wordlines, the one or more step static offsets including at least one of a program voltage step parameter or a program verify parameter.

At operation 540, the processing logic writes the data to the set of memory cells using the one or more step static offsets.

In some implementations, the processing logic unloads the one or more step static offsets responsive to writing the data to the set of memory cells. In some implementations, the processing logic writes the data to the memory device without using the one or more step static offsets responsive to the value of the media endurance metric being greater than or equal to the media endurance metric threshold or responsive to the wordline not being included in the list of wordlines.

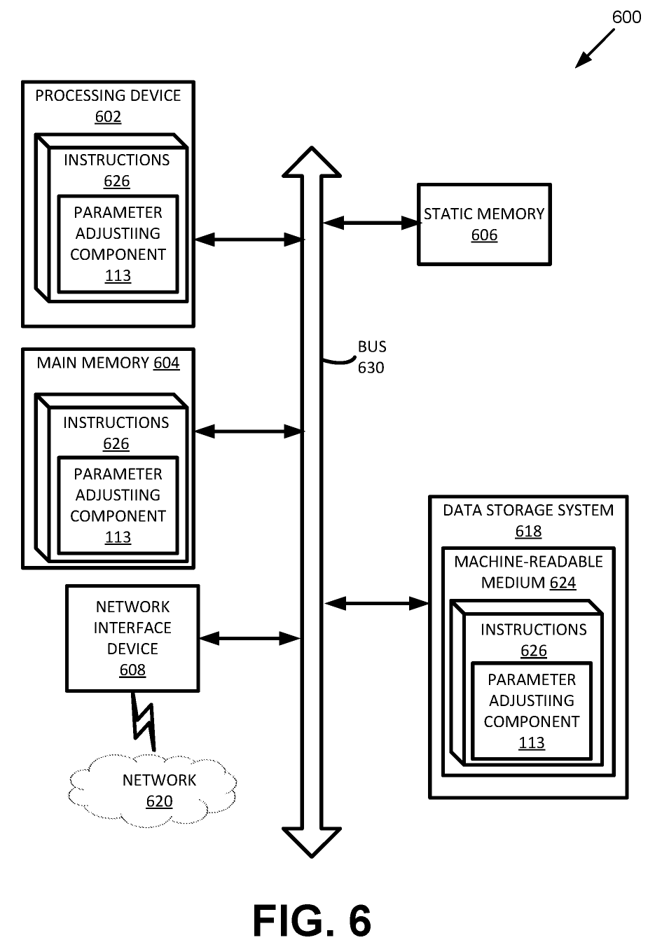

FIG. 6 illustrates an example machine of a computer system 600 within which a set of instructions, for causing the machine to perform any one or more of the methodologies discussed herein, can be executed. In some aspects, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the parameter adjusting component 113 of FIG. 1). In alternative aspects, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In some aspects, the instructions 626 include instructions to implement functionality corresponding to the parameter adjusting component 113 of FIG. 1). While the machine-readable storage medium 624 is shown in an example aspect to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some aspects, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, aspects of the disclosure have been described with reference to specific example aspects thereof. It will be evident that various modifications can be made thereto without departing from the broader spirit and scope of aspects of the disclosure as set forth in the following claims. The specification and drawings are, accordingly, to be regarded in an illustrative sense rather than a restrictive sense.

What is claimed is:

1. A system comprising: a memory device; and a processing device, coupled with the memory device, configured to perform operations comprising:
receiving a write command to write data to the memory device;
determining that the write command is associated with programming an operating system of the memory device;
responsive to determining that the write command is associated with the programming of the operating system of the memory device, loading a first set of values for respective parameters;
writing, using the first set of values, the data to the memory device; and
loading a second set of values for the respective parameters.

2. The system of claim 1, wherein the respective parameters include a timing parameter and an accuracy parameter.

3. The system of claim 2, wherein the first set of values includes a higher value for the timing parameter and a higher value for the accuracy parameter and the second set of values includes a lower value for the timing parameter and a lower value for the accuracy parameter.

4. The system of claim 1, wherein the processing device, to determine that the write command is associated with the programming of the operating system of the memory device, determines that the write command includes operating system data for programming an operating system of the memory device.

5. The system of claim 1, wherein the respective parameters are step static offset parameters that include at least one of a program voltage step parameter or a program verify parameter.

6. The system of claim 1, wherein a quantity of values in the first set of values is less than a quantity of values in the second set of values.

7. The system of claim 1, wherein the second set of values is a default set of values for writing standard data that is not associated with the programming of the operating system of the memory device.

8. The system of claim 1, wherein the processing device is further configured to perform operations comprising:
receiving a second write command to write second data to the memory device;
determining that the second write command is not associated with the programming of the operating system of the memory device; and
writing the second data to the memory device using the second set of values for the respective parameters.

9-16. (canceled)

17. A method comprising:
receiving a write command to write data to a memory device;
determining that the write command is associated with programming an operating system of the memory device;
responsive to determining that the write command is associated with the programming of the operating system of the memory device, loading a first set of values for respective parameters;
writing, using the first set of values, the data to the memory device; and
loading a second set of values for the respective parameters.

18. The method of claim 17, wherein the respective parameters include a timing parameter and an accuracy parameter.

19. The method of claim 18, wherein the first set of values includes a higher value for the timing parameter and a higher value for the accuracy parameter and the second set of values includes a lower value for the timing parameter and a lower value for the accuracy parameter.

20. The method of claim 17, wherein the respective parameters are step static offset parameters that include at least one of a program voltage step parameter or a program verify parameter.

21. A computer-readable non-transitory storage medium comprising executable instructions that, when executed by a controller managing a memory device, cause the controller to perform operations, comprising:
receiving a write command to write data to the memory device;
determining that the write command is associated with programming an operating system of the memory device;
responsive to determining that the write command is associated with the programming of the operating system of the memory device, loading a first set of values for respective parameters;
writing, using the first set of values, the data to the memory device; and
loading a second set of values for the respective parameters.

22. The computer-readable non-transitory storage medium of claim 21, wherein the respective parameters include a timing parameter and an accuracy parameter.

23. The system of claim 2, wherein the first set of values includes a higher value for the timing parameter and a higher value for the accuracy parameter and the second set of values includes a lower value for the timing parameter and a lower value for the accuracy parameter.

24. The computer-readable non-transitory storage medium of claim 21, wherein the processing device, to determine that the write command is associated with the programming of the operating system of the memory device, determines that the write command includes operating system data for programming an operating system of the memory device.

25. The computer-readable non-transitory storage medium of claim 21, wherein the respective parameters are step static offset parameters that include at least one of a program voltage step parameter or a program verify parameter.

26. The computer-readable non-transitory storage medium of claim 21, wherein a quantity of values in the first set of values is less than a quantity of values in the second set of values.

27. The computer-readable non-transitory storage medium of claim 21, wherein the second set of values is a default set of values for writing standard data that is not associated with the programming of the operating system of the memory device.

28. The computer-readable non-transitory storage medium of claim 21, wherein the processing device is further configured to perform operations comprising:
receiving a second write command to write second data to the memory device;
determining that the second write command is not associated with the programming of the operating system of the memory device; and
writing the second data to the memory device using the second set of values for the respective parameters.
